(19) United States
(12) Patent Application Publication
(10) Pub. No.: US 2025/0326525 A1
(43) Pub. Date: Oct. 23, 2025

(54) CONTAINER THAT ATTACHES TO THE TOP OF AN ALUMINUM BEVERAGE CAN

(71) Applicants: William Denkinger, Norwich, CT (US); Marta Obrotsa, Norwich, CT (US)

(72) Inventors: William Denkinger, Norwich, CT (US); Marta Obrotsa, Norwich, CT (US)

(21) Appl. No.: 19/240,265

(22) Filed: Jun. 17, 2025

Related U.S. Application Data
(60) Provisional application No. 63/635,008, filed on Apr. 17, 2024.

(51) Int. Cl. B65D 21/02; B65D 43/16; B67B 7/40

(52) U.S. Cl. CPC B65D 21/0223; B65D 21/0233; B65D 43/162; B67B 7/403

(57) ABSTRACT

A container for storing item(s) and/or comestible(s) that attaches to the top of an aluminum beverage can for the purpose of creating product combinations utilizing existing sales, packaging, and shipping infrastructure. The container is formed as a single item that is shaped to nest inside itself using minimal materials and making it easy to create, transport, and recycle.

### CROSS-REFERENCE TO RELATED APPLICATION

This application claims the benefit of priority of U.S. provisional application No. 63/635,008, filed Apr. 17, 2024 the contents of which are herein incorporated by reference.

### BACKGROUND OF THE INVENTION

The present invention relates generally to containers for storing items or comestibles and, more particularly, to a container that is designed to attach to the top of an aluminum beverage can, enabling the combination of a beverage and additional items into a single packaged unit.

In the current marketplace, beverages and comestibles are typically sold separately in various retail environments, such as grocery stores, convenience stores, and vending machines. This separation is largely due to the limitations of existing packaging designs, which do not allow for the integration of beverages and other items into a single, cohesive unit. As a result, consumers are often required to purchase these items individually, which can be inconvenient and inefficient.

Existing containers are not designed to attach to the top of an aluminum beverage can. Instead, they are typically standalone items that are sold separately. This lack of integration prevents the creation of product combinations that could otherwise enhance consumer convenience and provide new marketing opportunities for manufacturers.

Furthermore, current container designs and their associated packaging are not compatible with the infrastructure used for transporting, handling, and selling standard aluminum beverage cans. For example, refrigerated sales cases, vending machines, and other distribution systems are specifically designed to accommodate the dimensions and configurations of standard aluminum beverage cans. Containers that do not conform to these standards cannot be easily integrated into these systems, limiting their utility and marketability.

Additionally, while some container devices exist for storing items or comestibles, they are not designed to be affixed to aluminum beverage cans in a manner that allows for secure attachment, easy removal, and compatibility with existing sales and distribution infrastructure. These devices also fail to address the need for efficient stacking, nesting, and recycling, which are critical considerations in modern packaging design.

There is a need for a container that can securely attach to the top of an aluminum beverage can, enabling the combination of a beverage and additional items into a single, integrated unit. Such a container should be designed to match the dimensions of standard aluminum beverage cans, allowing it to be transported, handled, and sold using existing infrastructure. Additionally, the container should be constructed to allow for efficient stacking, nesting, and recycling, thereby minimizing material usage and environmental impact.

The present invention addresses these needs by providing a container with an integral lid that can attach to the top of an aluminum beverage can. The container is designed to be compatible with standard aluminum beverage can dimensions, enabling it to be used in existing sales and distribution systems. Furthermore, the container's design allows for secure attachment, easy removal, and efficient stacking and nesting, making it a practical and sustainable solution for combining beverages and additional items into a single packaged unit.

### SUMMARY OF THE INVENTION

The container is designed to attach to the top a standard aluminum beverage can so that a beverage and an item(s) or comestible(s) inside of the container can be packaged together as a single combination unit. The container can then be easily removed for the purpose of access and consumption. The dimensions of the container are related to the dimensions of a standard aluminum beverage can so that they can be sold and conveyed in existing infrastructure such as refrigerated sales cases and vending machines.

The storage container is able to pair with a standard aluminum beverage can resulting in numerous combinations of beverage(s) and item(s) or comestible(s) that can be sold together in a single transaction which current containers and packaging do not allow.

In one embodiment of the container, the lid is formed in a shape that allows for additional beverage cans, additional containers, or additional combinations of the two (attached and unattached) to be stacked repeatedly atop of the container.

In another embodiment of the container, the lid is formed in a smooth shape that allows for labelling, branding, and marketing materials to be applied to the exterior of the container.

The size and shape of the container allows it to be transported, handled, conveyed, marketed and sold using devices, apparatuses, and packaging already in use and designed for the purpose of transporting, handling, conveying, marketing and selling of standard sized aluminum beverage cans.

The containers attachment mechanism, body and lid are all created as a single molded object allowing it to use minimal materials for its production and ease of recycling.

Furthermore, the shape of the container allows empty containers to nest inside each other allowing efficient transport of the container prior to packaging of its contents and after it has been discarded and recycled.

These and other features, aspects and advantages of the present invention will become better understood with reference to the following drawings, description and claims.

### BRIEF DESCRIPTION OF THE DRAWINGS

FIG. 1 illustrates an isometric view of an embodiment of the container with an integral stackable lid in a closed position;

FIG. 2 illustrates an isometric view of an embodiment of the container with an integral smooth lid in an open position;

FIG. 3 illustrates an elevation view of an embodiment of the container with an integral stackable lid in a closed position;

FIG. 4 illustrates a section view of an embodiment of the container with an integral stackable lid in a closed position;

FIG. 5 illustrates a top view of the lid of an embodiment of the container with an integral stackable lid;

FIG. 6 illustrates an enhanced section of the lid of an embodiment of the container with an integral stackable lid;

FIG. 7 illustrates an enhanced section of an embodiment of the container with an integral stackable lid of the lid sealing portion that locks the lid closed to the main body and the opening tab protrusion;

FIG. 8 illustrates an enhanced section of an embodiment of the container with an integral stackable lid of the lid hinge that connects the lid of the container to the body of the container;

FIG. 9 illustrates an elevation view of the lid of an embodiment of the container with an integral smooth lid in a closed position;

FIG. 10 illustrates a section view of the lid of an embodiment of the container with an integral smooth lid in a closed position;

FIG. 11 illustrates a top view of the lid of an embodiment of the container with an integral smooth lid;

FIG. 12 illustrates an enhanced section of the lid of an embodiment of the container with an integral smooth lid;

FIG. 13 illustrates an enhanced section of an embodiment of the container with an integral smooth lid of the lid sealing portion that locks the lid closed to the main body and the opening tab protrusion;

FIG. 14 illustrates an enhanced section of an embodiment of the container with an integral smooth lid of the lid hinge that connects the lid of the container to the body of the container;

FIG. 15 illustrates an enhanced section of an embodiment of the container with an integral smooth lid of the lid lapping portion that laps the lid closed over the containers main body;

FIG. 16 illustrates an enhanced section of an embodiment of the container with an integral stackable lid of the lid lapping portion that laps the lid closed over the containers main body;

FIG. 17 illustrates a bottom view of the container;

FIG. 18 illustrates an enhanced section of the base of the container;

FIG. 19 illustrates an enhanced section at the rim attachment mechanism;

FIG. 20 illustrates an enhanced section at the base edge of the container;

FIG. 21 illustrates a section view of an embodiment of the container with an integral stackable lid in an open position;

FIG. 22 illustrates an elevation view from the side of an embodiment of the container with an integral stackable lid in an open position;

FIG. 23 illustrates an elevation view from the front of an embodiment of the container with an integral stackable lid in an open position;

FIG. 24 illustrates a section view of an embodiment of the container with an integral smooth lid in an open position;

FIG. 25 illustrates an elevation view from the side of an embodiment of the container with an integral smooth lid in an open position;

FIG. 26 illustrates an elevation view from the front of an embodiment of the container with an integral smooth lid in an open position;

FIG. 27 illustrates a section view of an embodiment of the container with an integral stackable lid affixed to the top of an aluminum beverage can;

FIG. 28 illustrates an elevation view of an embodiment of the container with an integral stackable lid affixed to the top of an aluminum beverage can;

FIG. 29 illustrates an enhanced section view of the base of the container affixed to the top of an aluminum beverage can;

FIG. 30 illustrates an enhanced section view of the base of an aluminum beverage can sitting atop an embodiment of the container with an integral stackable lid;

FIG. 31 illustrates an enhanced section view of the base of the container sitting atop an embodiment of the container with an integral stackable lid;

FIG. 32 illustrates an isometric view of an embodiment of the container with an integral smooth lid in the closed position affixed to the top of an aluminum beverage can;

FIG. 33 illustrates an isometric view of an embodiment of the container with an integral stackable lid in the closed position affixed to the top of an aluminum beverage can;

FIG. 34 illustrates a section view of an embodiment of the container with an integral stackable lid affixed to the top of an aluminum beverage can and further demonstrates its ability to continue stacking additional aluminum beverage cans atop of it;

FIG. 35 illustrates a section view of an embodiment of the container with an integral stackable lid affixed to the top of an aluminum beverage can and further demonstrates its ability to continue stacking additional containers atop of it;

FIG. 36 illustrates an isometric view of an embodiment of the container with an integral smooth lid in the open position prior to being affixed to the top of an aluminum beverage can;

FIG. 37 illustrates an isometric view of an embodiment of the container with an integral smooth lid in the open position affixed to the top of an aluminum beverage can;

FIG. 38 illustrates a section view of an embodiment of the container with an integral stackable lid demonstrating its ability to repeatedly stack repeatedly upon itself;

FIG. 39 illustrates an elevation view of an embodiment of the container with an integral stackable lid demonstrating its ability to repeatedly stack repeatedly upon itself;

FIG. 40 illustrates an isometric view of an embodiment of the container with an integral stackable lid demonstrating its ability to repeatedly stack repeatedly upon itself;

FIG. 41 illustrates an elevation view of an embodiment of the container with an integral stackable lid in an open position demonstrating its ability to repeatedly stack and nest inside itself;

FIG. 42 illustrates a section view of an embodiment of the container with an integral stackable lid in an open position demonstrating its ability to repeatedly stack and nest inside itself;

FIG. 43 illustrates an elevation view of an embodiment of the container with an integral smooth lid in an open position demonstrating its ability to repeatedly stack and nest inside itself;

FIG. 44 illustrates a section view of an embodiment of the container with an integral smooth lid in an open position demonstrating its ability to repeatedly stack and nest inside itself;

FIG. 45 illustrates an elevation view of a small version of an embodiment of the container with an integral smooth lid;

FIG. 46 illustrates an elevation view of a medium version of an embodiment of the container with an integral smooth lid;

FIG. 47 illustrates an elevation view of a large version of an embodiment of the container with an integral smooth lid;

FIG. 48 illustrates an elevation view of an extra-large version of an embodiment of the container with an integral smooth lid;

FIG. 49 illustrates an elevation view of a small version of an embodiment of the container with an integral stackable lid;

FIG. 50 illustrates an elevation view of a medium version of an embodiment of the container with an integral stackable lid;

FIG. 51 illustrates an elevation view of a large version of an embodiment of the container with an integral stackable lid;

FIG. 52 illustrates an elevation view of an extra-large version of an embodiment of the container with an integral stackable lid;

FIG. 53 illustrates a 16 oz Standard aluminum can;

FIG. 54 illustrates an embodiment of the container stacked on an aluminum beverage container;

FIG. 55 illustrates an embodiment of the container stacked on an aluminum beverage container;

FIG. 56 illustrates an embodiment of the container stacked on an aluminum beverage container;

FIG. 57 illustrates a 12 oz Standard aluminum can;

FIG. 58 illustrates an embodiment of the container stacked on an aluminum beverage container;

FIG. 59 illustrates an embodiment of the container stacked on an aluminum beverage container;

FIG. 60 illustrates an embodiment of the container stacked on an aluminum beverage container;

FIG. 61 illustrate a common version of “Standard” aluminum can for reference purposes;

FIG. 62 illustrate a common version of “Standard” aluminum can for reference purposes;

FIG. 63 illustrate a common version of “Standard” aluminum can for reference purposes;

FIG. 64 illustrate a common version of “Standard” aluminum can for reference purposes.

FIG. 65 illustrate a common version of “Standard” aluminum can for reference purposes;

FIG. 66 illustrate a common version of “Standard” aluminum can for reference purposes; FIG. 67 illustrates a common version of a “King” aluminum can for reference purposes;

FIG. 68 illustrates a common version of a “King” aluminum can for reference purposes;

FIG. 69 illustrates a common version of a “King” aluminum can for reference purposes;

FIG. 70 illustrates a common version of a “King” aluminum can for reference purposes;

FIG. 71 illustrates a common version of a “Sleek” aluminum can for reference purposes;

FIG. 72 illustrates a common version of a “Sleek” aluminum can for reference purposes;

FIG. 73 illustrates a common version of a “Sleek” aluminum can for reference purposes;

FIG. 74 illustrates a common version of a “Sleek” aluminum can for reference purposes;

FIG. 75 illustrates a common version of a “Sleek” aluminum can for reference purposes;

FIG. 76 illustrates a common version of a “Sleek” aluminum can for reference purposes;

FIG. 77 illustrates a common version of a “Slim” aluminum can for reference purposes;

FIG. 78 illustrates a common version of a “Slim” aluminum can for reference purposes; and

FIG. 79 illustrates a common version of a “Slim” aluminum can for reference purposes.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

### ENUMERATION OF PARTS AND REFERENCES

100. Container version with stacking lid medium size
101. Container version body detail with stacking lid
102. Lid portion of container with stacking lid
103. Rim hold
104. Rim hold form opening
105. Raised edge opening
106. Raised edge
107. Lid depression
108. Raised center
109. Opening Tab
110. Container grasping protrusion
111. Interior of container
112. Lid lapping protrusion
113. Lid grasping protrusion
114. Lid hinge
115. Outside eased edge
116. Inside eased edge
117. Smooth lid version edge curve
118. Rim hold base curve
119. Container base edge
120. Container lapping protrusion
121. Rim hold protrusion
160. Container version of stackable container small size
170. Container version of stackable container large size
180. Container version of stackable container extra-large size
200. Container version with smooth lid medium size
201. Container version body detail with smooth lid
202. Lid portion of container with smooth lid
260. Container version with smooth lid small size
270. Container version with smooth lid large size
280. Container version with smooth lid extra-large size
300. 8.4 oz Standard aluminum can with 211 body with 202 top rim for reference
301. Standard aluminum can 202 top rim for reference
302. Standard aluminum can with 211 body top shape rim for reference
303. Standard aluminum can with 211 body base shape rim for reference
310. 11.02 oz Standard aluminum can with 211 body with 202 top rim for reference
320. 12 oz Standard aluminum can with 211 body with 202 top rim for reference
330. 15.2 oz Standard aluminum can with 211 body with 202 top rim for reference
340. 16 oz Standard aluminum can with 211 body with 202 top rim for reference
350. 16.9 oz Standard aluminum can with 211 body with 202 top rim for reference
360. 24 oz “King” size aluminum can with 209 body with 206 top rim for reference
370. 25.4 oz “King” size aluminum can with 300 OSR top rim for reference
380. 32 oz “King” size aluminum can with 300 OSR top rim for reference
390. 33.8 oz “King” size aluminum can with 307 body with 209 top rim for reference
400. 6.8 oz “Sleek” size aluminum can with 204 body with 202 top rim for reference
410. 8.4 oz “Sleek” size aluminum can with 204 body with 202 top rim for reference
420. 9.1 oz “Sleek” size aluminum can with 204 body with 202 top rim for reference
430. 10.5 oz “Sleek” size aluminum can with 204 body with 202 top rim for reference
440. 11.2 oz “Sleek” size aluminum can with 204 body with 202 top rim for reference
450. 12 oz “Sleek” size aluminum can with 204 body with 202 top rim for reference
500. 5.8 oz “Slim” size aluminum can with 202 body with 200 top rim for reference
510. 6.8 oz “Slim” size aluminum can with 202 body with 200 top rim for reference
520. 8.4 oz “Slim” size aluminum can with 202 body with 200 top rim for reference

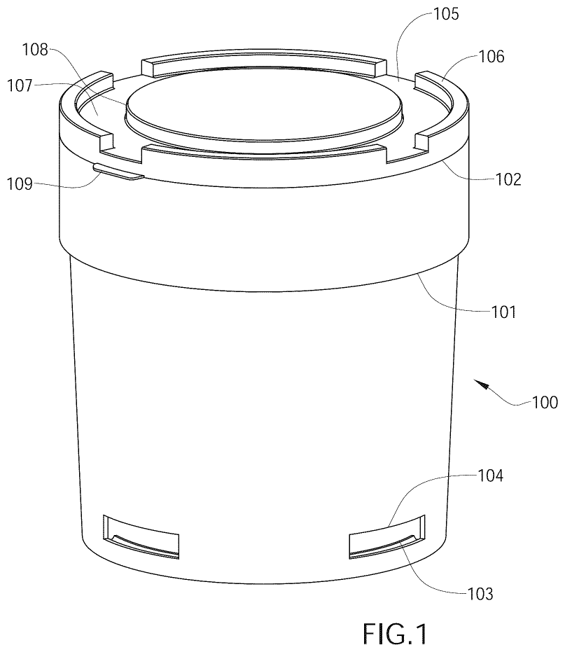

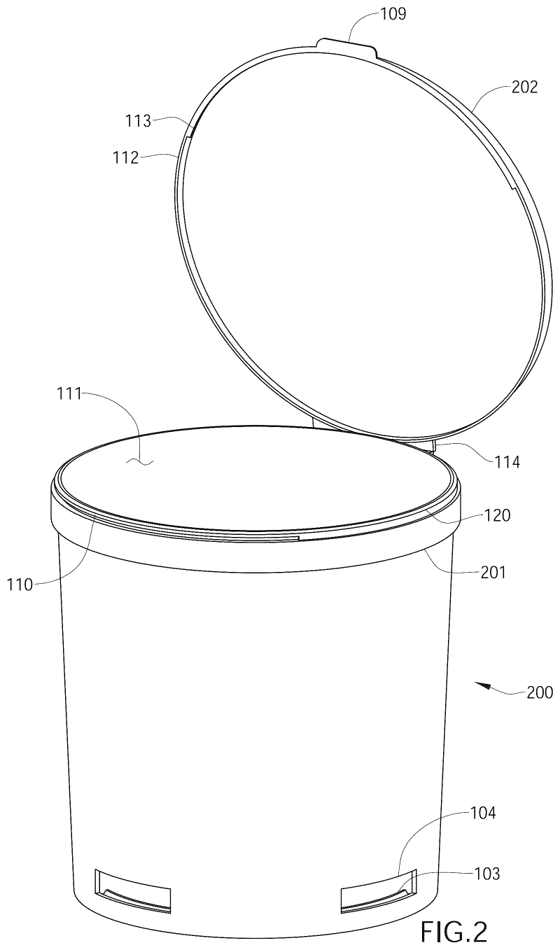

Referring to FIGS. 1-79, FIG. 1 shows an embodiment of the container 100 with a stacking version of the lid portion 102. The container is round in plan and generally has the shape of a cylinder. The container and its lid are constructed and formed as one and are a single item. The body of the container has a detail 101 best seen in FIG. 4, that transitions the straight vertical body at the top to a sloped body towards its base. The location of detail 101 on the container can vary in different iterations of the container, an alternative location is seen in FIG. 2 detail 201.

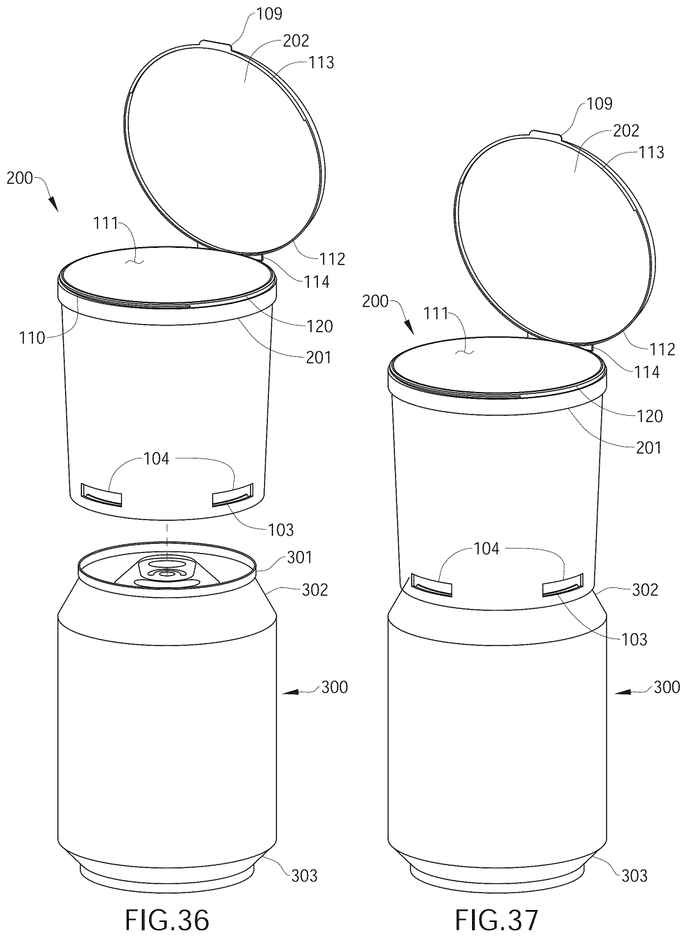

The top portion of the container above details 101 and 201 has a diameter equal to that of the diameter of the specific aluminum beverage container or can body 300 it is designed to attach to the top of. There are several body diameters for standard aluminum beverage containers and cans, including but not limited to standard size cans consisting of the industry known “211 brite can” 300 that uses a “202 can end” 301 or top portion that contains the opening tab and spout FIG. 36.

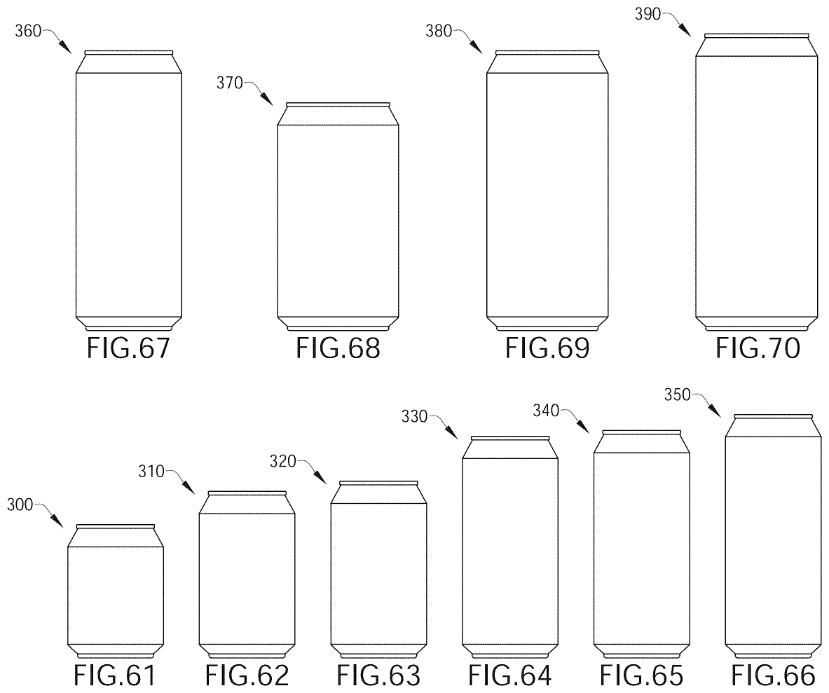

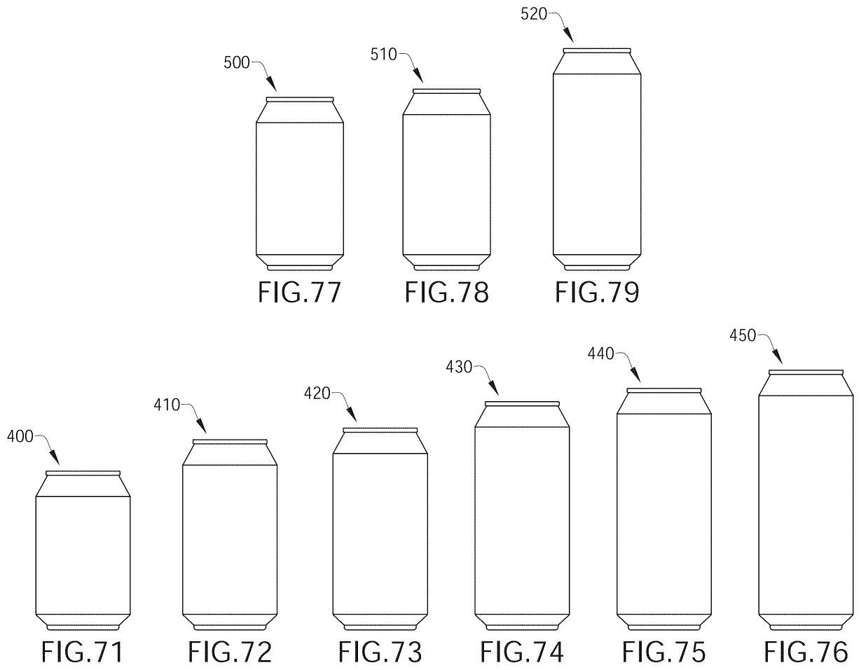

The container 100 is to be constructed in many sizes matching the diameter of standard cans with size “211 brite cans” and size “202 can ends” FIG. 61-FIG. 66, the figures showing the various volumes these cans come in 8.4 oz-16.9 oz. Other versions of cans also exist including “King Cans” that feature oversized can diameters with larger brites and can ends FIG. 67-FIG. 70. Additional sizes of aluminum cans have become popular in recent years including “Sleek Cans” with narrower size “204 brite can” bodies and size “202 can ends” FIG. 71-FIG. 76. And “Slim Cans” with even narrower size “202 brite can” bodies and “200 can ends” FIG. 77-FIG. 79. The container 100 and all of its embodiments and iterations, including 200, would be manufactured in matching diameters to these cans, however, the invention is not limited, and any size container may be employed.

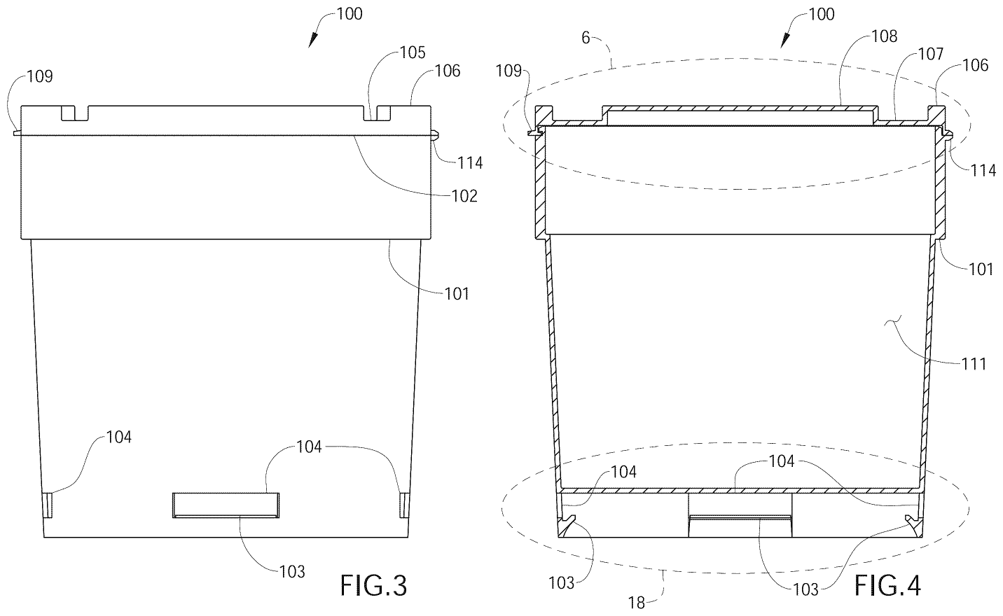

FIG. 3 shows an elevation view of the container 100 with a stacking lid portion 102. FIG. 4 shows a section view of the container 100 with a stacking lid portion 102. FIG. 4 Shows a section view of the container with it's interior chamber 111 for the storage of items or comestible inside of the container.

The base of the container has four rim holds 103 designed to slide over and grasp the top can end 301 of the aluminum beverage containers or cans shown in FIG. 67-FIG. 79, however, the invention is not limited to four rim holds 103 and any number may be employed.

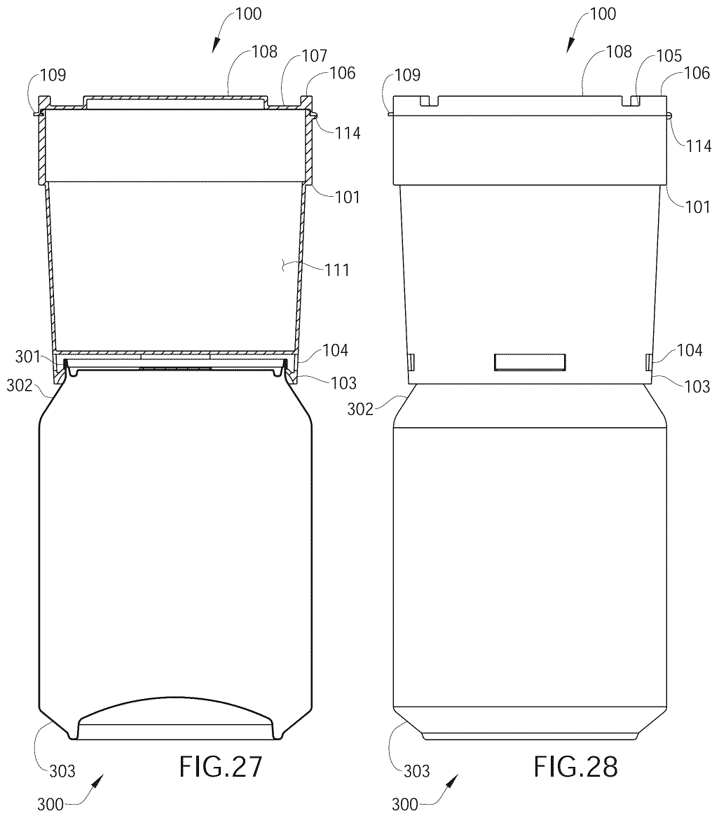

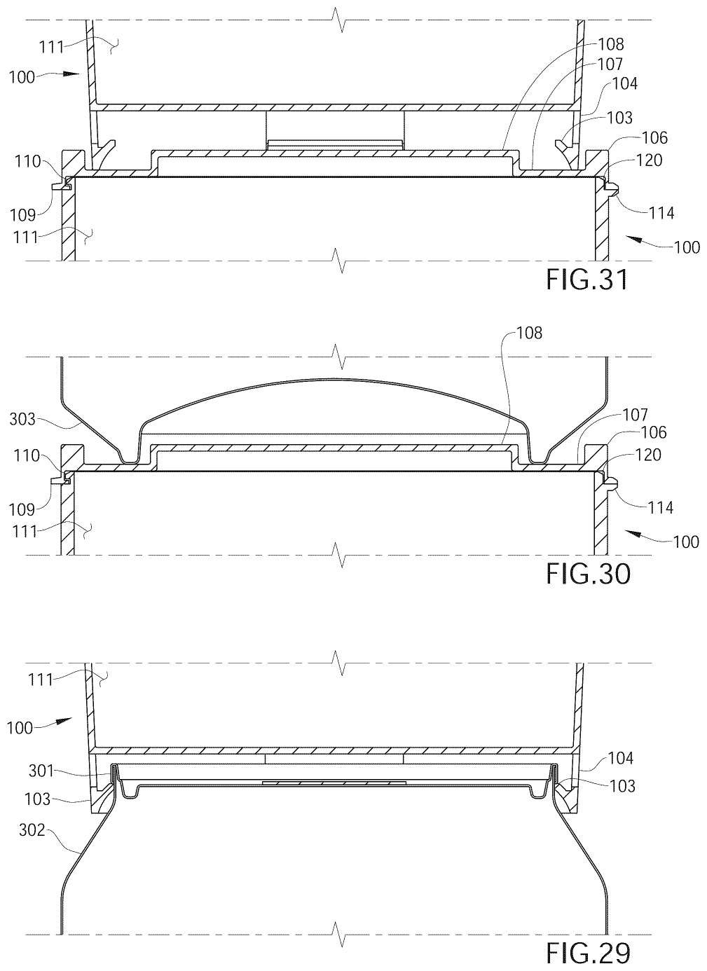

A detailed section of the container grasping the top of an aluminum beverage container of can is best seen in FIG. 29. A full section and elevation of the container 100 affixed to the top of a standard aluminum beverage container 300 are portrayed in FIG. 27-FIG. 28.

Rim hold form openings 104 are located above the rim holds and are for the purpose of forming the container and for access during attachment and removal of the container to the top of aluminum beverage cans known as can ends 301, however, the invention may also have iterations and embodiments that do not contain rim hold form openings 104 when not required by their application and use.

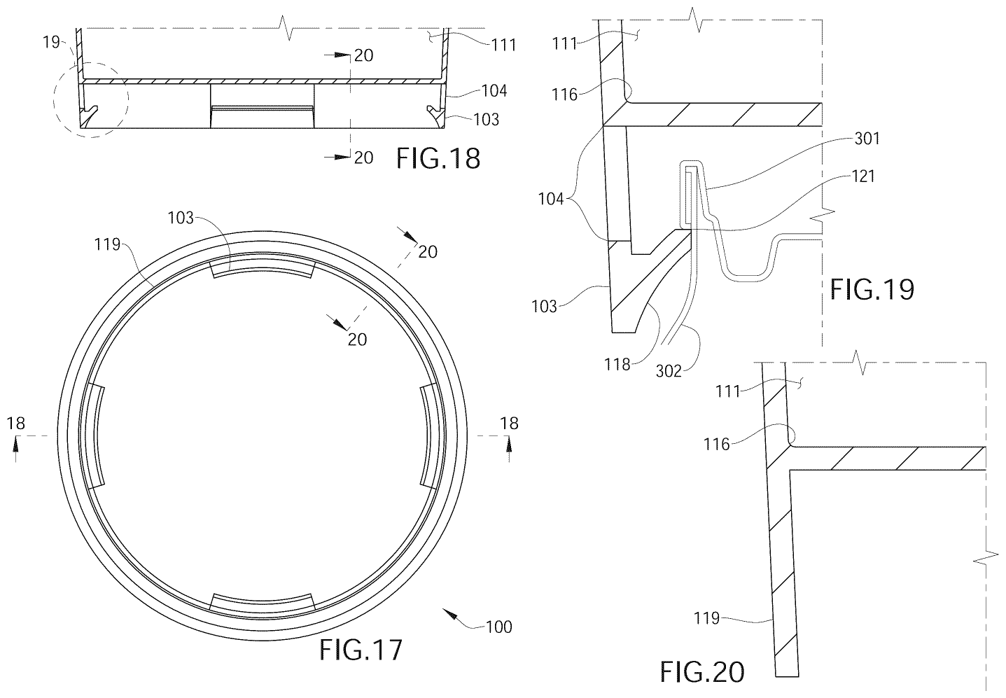

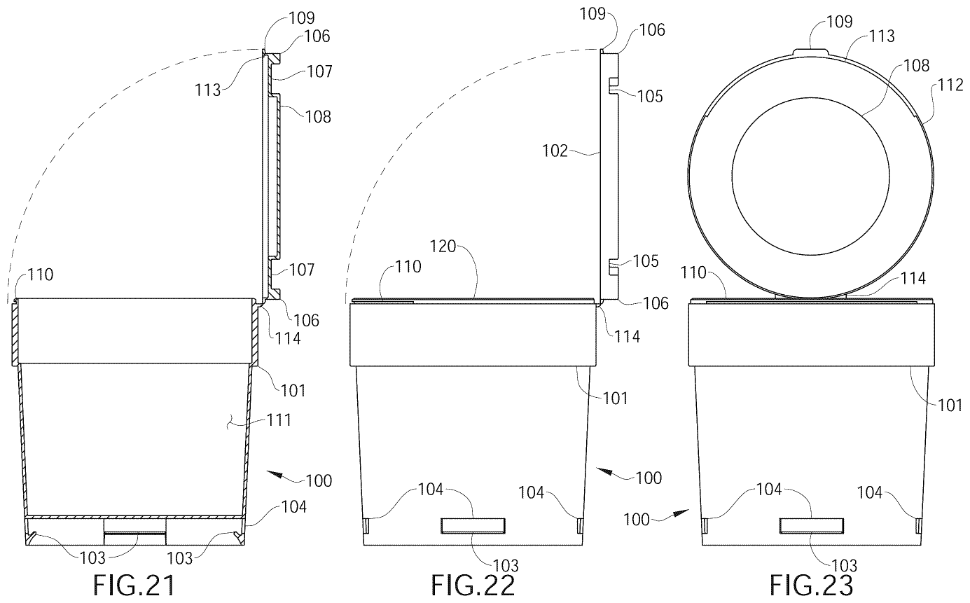

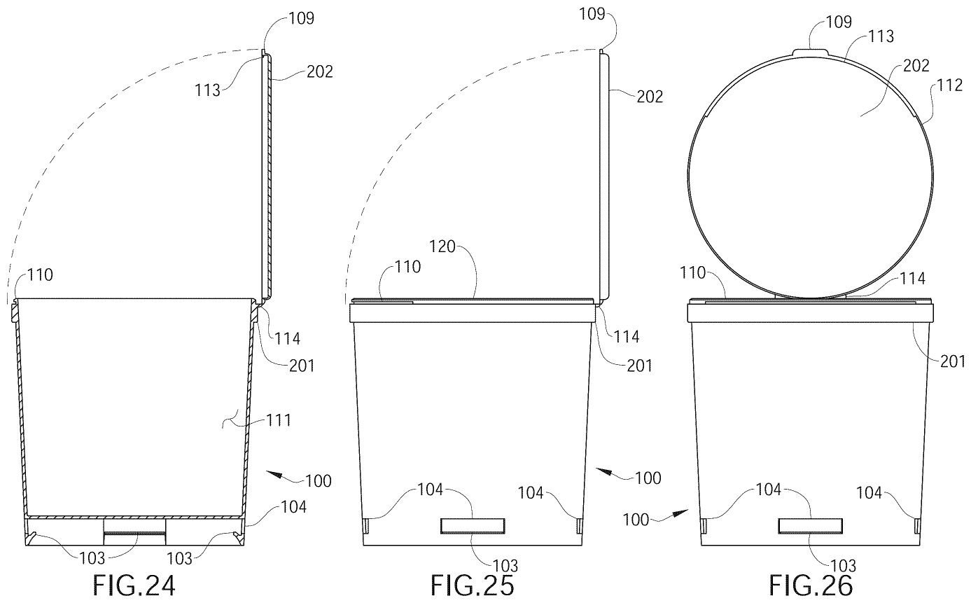

FIG. 17. shows a bottom view of the container. Rim holds 103 and accompanying rim hold form openings 104, if present, on the embodiment of the container are equally spaced around the circumference of the round container to ensure a firm grasp to the top can end 301 of the aluminum beverage container or can. FIG. 19 shows an enlarged detail of the rim holds 103 and rim hold form openings 104. Because the container is made from flexible plastic material, the shape of rim hold 103 is able to bend to allow the container to be attached and removed from the top of a can end 301 and return to its original shape without breaking.

The inside face of the rim holds 103 have a curve 118 to allow the container to slide easily over the top can end 301 of the aluminum beverage container or can. A protrusion 121 extending from the end of the rim hold deforms when being installed then snaps back into shape to grasp the underside of the “lip” the can end 301 forms with the top of the cans body 302. The flexibility of the plastic also allows the container 100 to be removed when applying lateral and upward force to the container away from the aluminum beverage container it is attached. The base of the container is a continuous circle form 119 that's section is shown in FIG. 20 and is only interrupted by rim holds 103 and rim hold openings 104, when they occur. Eased edges are provided at inside edges 116 on the interior of the container 111 to assist in forming of the container and to prevent any buildup of the container's contents.

FIG. 3-FIG. 5 show the container 100 with a stacking version of the lid portion 102 has a lid depression 107 that is shaped for the purpose of allowing the base 303 of an aluminum beverage container or can 300 (as well as the bases of all other aluminum beverage containers shown in FIG. 67-FIG. 79 and other iterations and embodiments of the container) to sit comfortable atop of its lid that can best be seen in the detailed section shown in FIG. 30. This embodiment of the lid has a raised edge 106, to assist in preventing the aluminum beverage container or can 300 from falling off or over.

The raised edge of the container 106 has four interruptions or raised edge openings 105 in this embodiment that allow for any liquid or condensate that falls on top of the container to drain off the top of the container. The invention is not limited to four raised edge openings 103 and any number may be employed or even no raised edge openings may be employed. The center of the lid portion 102 has a raised center 108 that also assists in preventing aluminum beverage containers or cans 300 from falling off or over when set on top of the container FIG. 30 as well as other containers 100 when set on top of the container FIG. 31.

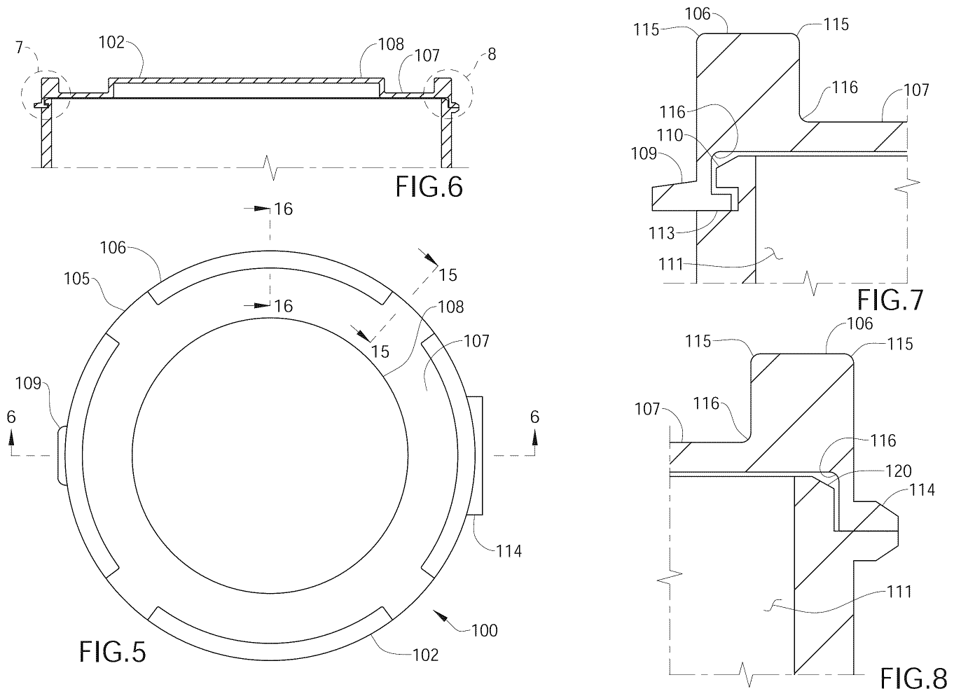

FIG. 5-FIG. 8 show an opening tab 109 is formed as an extension of the lid to assist in opening and closing of the container and located opposite of the hinge 114. FIG. 5-FIG. 8 show the hinge 114 of the lid portion 102 is formed integral with the body of the container 100 and allows for opening and closing. Eased edges are provided at outside edges 115 and inside edges 116 to assist in forming and handling of the container.

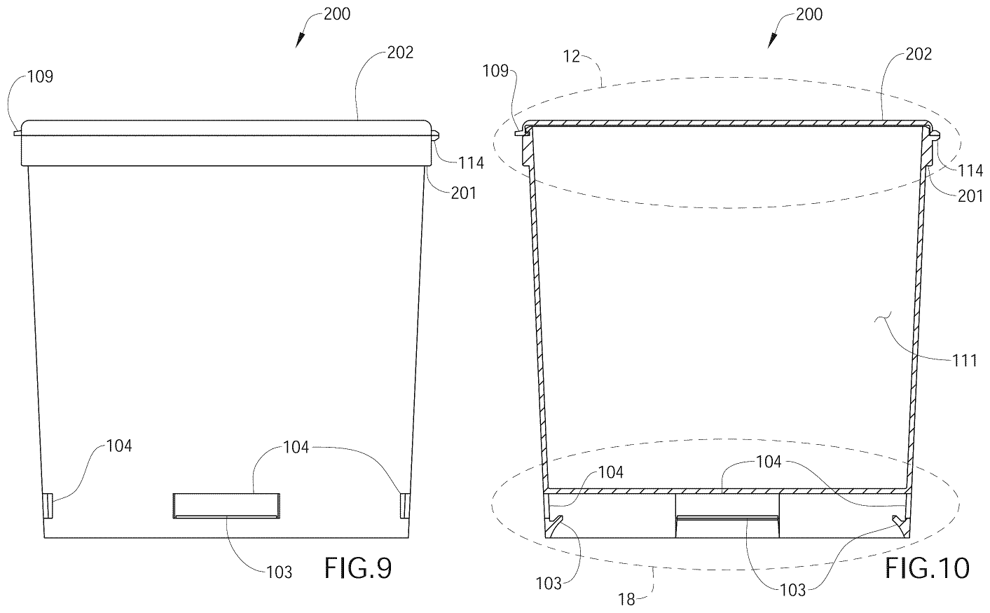

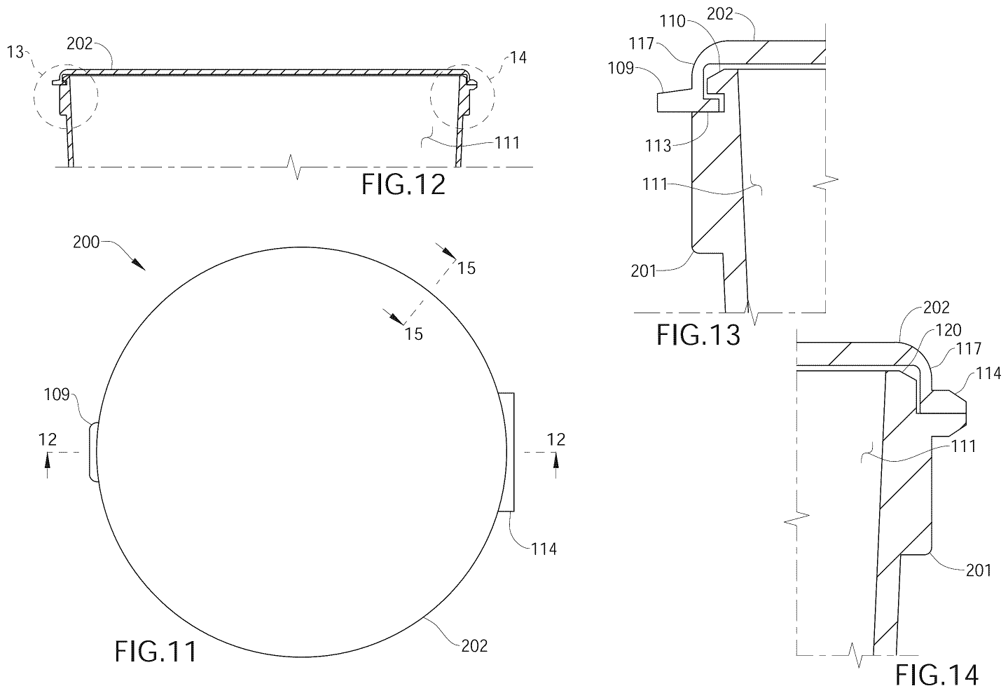

FIG. 9-FIG. 11 show the container 200 with a smooth portion of the lid 202 is flat on top and has a rolling curve all the way around its edge 117. FIG. 10 shows a section view of the container with it's interior chamber 111 for the storage of items or comestible inside of the container. FIG. 11-FIG. 14 show an opening tab 109 is formed as an extension of the lid to assist in opening and closing of the container and located opposite of the hinge 114. FIG. 11-FIG. 14 show the hinge 114 of the lid portion 202 is formed integral with the body of the container 200 and allows for opening and closing.

For the purpose of closing and sealing the container 100 and all of its embodiments and iterations FIG. 7 a grasping protrusion extends from the containers circular rim 110 in order to receive the circular lids grasping protrusion 113. FIG. 23 show the lid grasping protrusion is located predominantly around the opening tab side of the circular lid 102. The protrusion and its length around the edge of the circular lid and the circular body of the container Is not limited to the extent shown in FIG. 23 and can vary between different iterations and embodiments of the container.

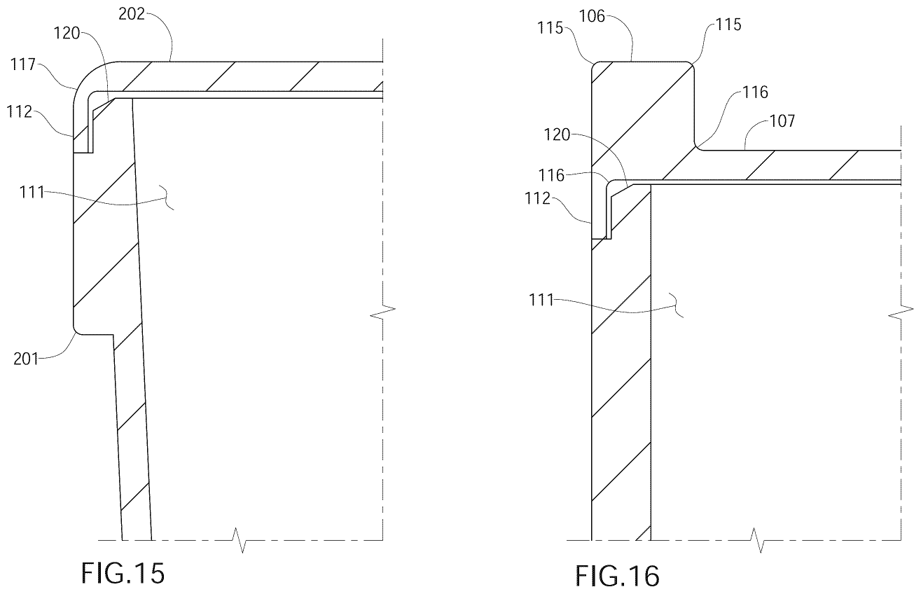

When the lid is closed, the lid grasping protrusion 113 snaps over the container grasping protrusion 110 to seal and lock the lid in place and is best seen in FIG. 7. Portions of the lid 102 that do not have a locking protrusion lap over the container as best seen in FIG. 15-FIG. 16

The container's opening rim in these areas has a lapping protrusion 120 that is shaped so that the lid's lapping protrusion 112 laps over the rim of the opening. Containers 200 with the smooth version of the lid 202 utilize the same or similar hinging, closing, and lid locking mechanisms as described above and are shown in FIG. 11-FIG. 14.

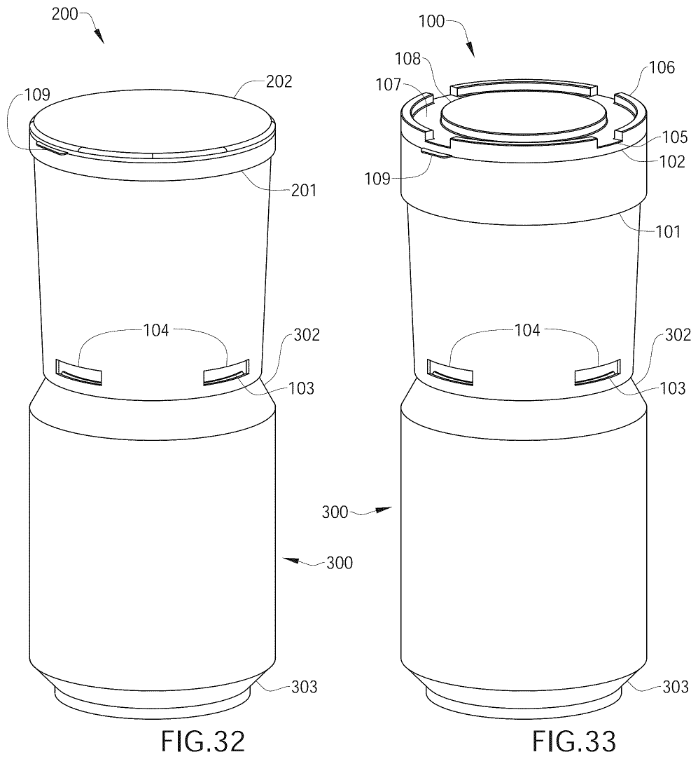

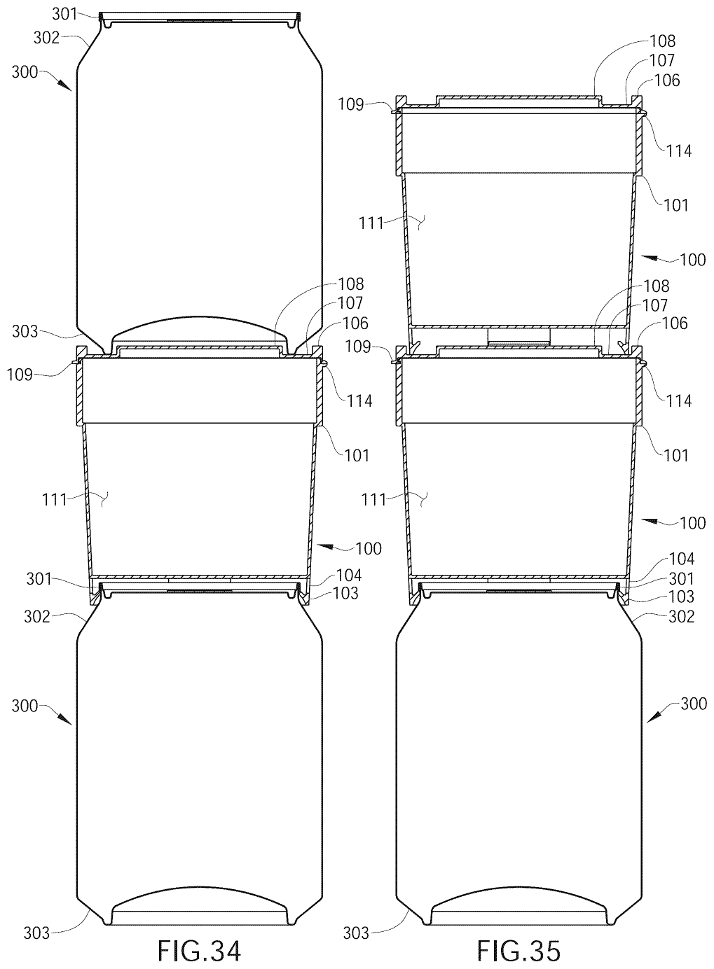

FIG. 32-FIG. 33 demonstrate both iterations 100 and 200 of the container described above in isometric view attached to the top of a standard aluminum beverage container or can 300. FIG. 34 further demonstrates how the combination of container 100 affixed to the top of an aluminum beverage container or can 300, can be stacked repeatedly with additionally cans 300.

FIG. 35 demonstrates that additional containers can also be stacked repeatedly on top of the combination of container 100 affixed to the top of an aluminum beverage container or can 300. Likewise, additional connected combination of the container 100 affixed to the top of an aluminum beverage container or can 300 can be stacked endlessly atop one another.

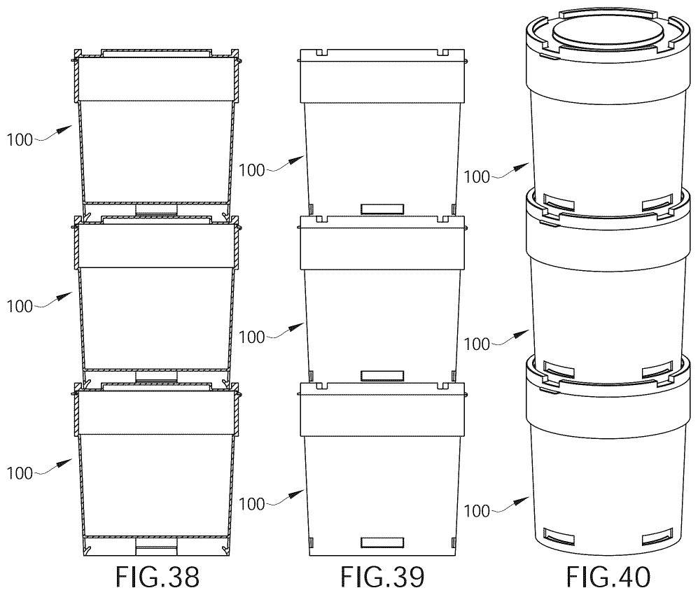

FIG. 38-FIG. 40 demonstrate for the purpose of shipping and transporting the container with its lid in the closed position, whether empty or containing items or comestibles, the containers can be stacked endlessly atop one another.

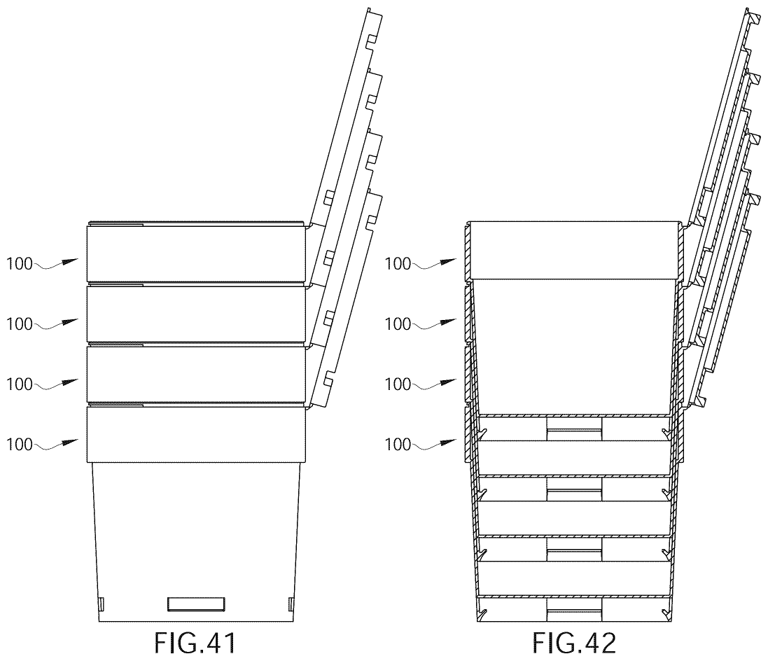

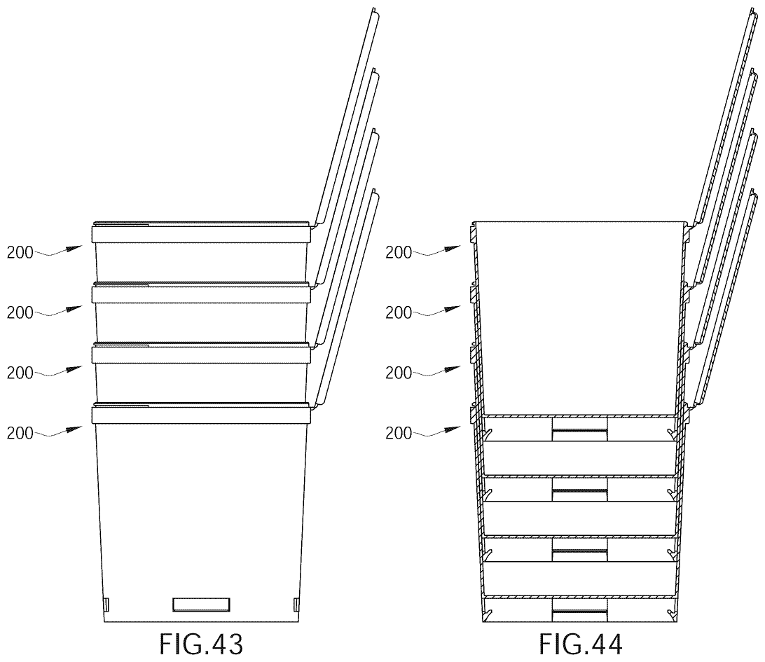

FIG. 41-FIG. 44 demonstrate that due to the sloped outer walls of the container, when empty and their integral formed lids are in the open position, they are able to stack and nest in one another for the ease and efficiency of transporting the containers while empty. All embodiments of the container shown and not shown are able to utilize this nesting capability, however, the invention may also have iterations and embodiments that are unable to nest stack and nest inside each other in the open position depending on the size and requirements of the item or items contained inside.

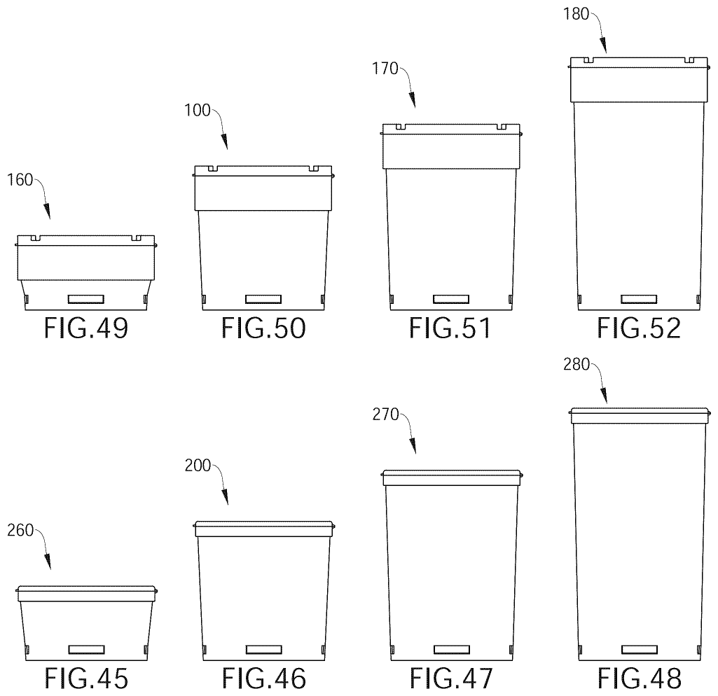

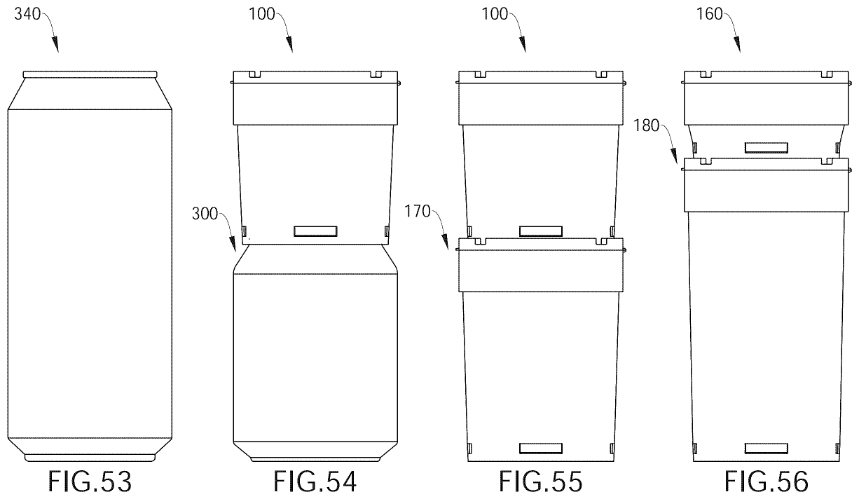

FIG. 45-FIG. 52 show various iterations and embodiment of the container in different size options that when affixed to the top of a standard aluminum beverage container are substantially similar in size of larger versions of standard aluminum beverage containers. To demonstrate this, FIG. 53 shows a 16 oz Standard aluminum can with 211 body with 202 top rim 340.

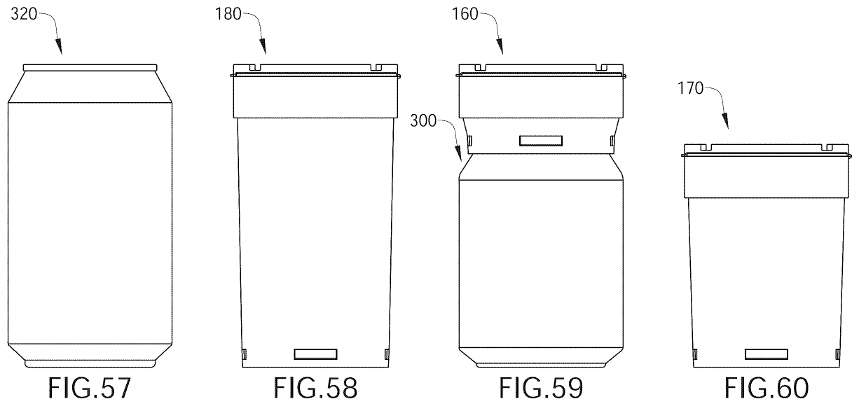

FIG. 54 shows the container 100 affixed to the top of an 8.4 oz standard aluminum can with 211 body with 202 top rim 300 with the same height as the 16 oz can 340 in FIG. 53. FIG. 55 shows the container stacked atop another version of the container 170 with the same height as the 16 oz can 340 in FIG. 53. FIG. 56 shows an alternative combination of containers 160 and 180 with the same height as the 16 oz can 340 in FIG. 53. FIG. 57 shows a 12 oz standard aluminum can with 211 body with 202 top rim 320. FIG. 58 shows a version of the container matching the height of a 12 oz. aluminum can 320.

FIG. 59 further demonstrates the combination of container 160 affixed atop of an 8.4 oz standard aluminum can with 211 body with 202 top rim 300, this combination matching the height of the 12 oz. aluminum can 320. The ability for the container to be substantially similar in size and dimensions to existing standard aluminum beverage cans FIG. 61-FIG. 79, it is able to be transported, handled, conveyed, marketed and sold using devices, apparatuses, and packaging already in use and designed for the purpose of transporting, handling, conveying, marketing and selling of standard aluminum beverage cans. However, the invention is not limited, and any size container may be employed.

It should be understood, of course, that the foregoing relates to exemplary embodiments of the invention and that modifications may be made without departing from the spirit and scope of the invention as set forth in the following claims.

What is claimed is:

1. A container comprised of a body with an integral lid that is able to attach to the top of an aluminum beverage can.

2. The container in claim 1, wherein the containers outer diameter matches the diameter of the aluminum beverage can it is designed to attach atop.

3. The container in claim 1, wherein the containers circular lid is able to lock closed to form a seal with the containers circular body.

4. The container in claim 1, wherein the containers lid has a tab to increase ease of opening.

5. The container in claim 1, wherein the containers base contains rim holds allowing it to attach to the top of an aluminum beverage can.

6. The container in claim 1, wherein the container is able to subsequently be easily removed from the top of an aluminum beverage can.

7. The container in claim 1, wherein the containers lid allows for additional aluminum beverage cans to stack atop the container.

8. The container in claim 1, wherein the containers lid allows for additional containers to stack atop the container.

9. The container in claim 1, wherein the containers sloped body allows it to nest repeatedly inside of the container so that multiple empty containers can be efficiently stacked and transported.

10. The container in claim 1, wherein various sizes of the container when combined with aluminum beverage cans matches the height and general dimensions of other versions of aluminum beverage cans.

11. A container for attachment to the top of an aluminum beverage can, comprising:
a cylindrical body having an outer diameter substantially matching the diameter of the aluminum beverage can to which it is designed to attach;
an integral lid connected to the cylindrical body via a hinge, the lid configured to open and close relative to the cylindrical body;
a rim hold mechanism located at the base of the cylindrical body, the rim hold mechanism comprising a plurality of flexible protrusions configured to engage the top rim of the aluminum beverage can;
a lid locking mechanism comprising a lid locking protrusion on the lid and a corresponding container lid receiving protrusion on the cylindrical body, the lid locking mechanism configured to secure the lid in a closed position;
wherein the container is constructed as a single molded object.

12. The container of claim 11, wherein the rim hold mechanism further comprises:
a rim hold base curve on the inside face of each flexible protrusion, the rim hold base curve configured to facilitate sliding engagement with the top rim of the aluminum beverage can;
a rim hold form opening located above each flexible protrusion, the rim hold form opening providing access for attachment and removal of the container from the aluminum beverage can.

13. The container of claim 11, wherein the lid further comprises:
a raised edge surrounding the perimeter of the lid, the raised edge configured to prevent items stacked atop the lid from falling off;
a lid depression located centrally on the lid, the lid depression configured to receive the base of an aluminum beverage can stacked atop the container.

14. The container of claim 13, wherein the raised edge further comprises:
a plurality of raised edge openings spaced around the perimeter of the lid, the raised edge openings configured to allow liquid or condensate to drain off the lid.

15. The container of claim 11, wherein the cylindrical body further comprises:
a sloped outer wall transitioning from a straight vertical body at the top to a narrower base, the sloped outer wall configured to allow multiple containers to nest inside one another when empty.

16. The container of claim 11, wherein the container is configured to attach to a “Standard” aluminum can having a 211 body and a 202 top rim.

17. The container of claim 11, wherein the container is configured to attach to a “King” aluminum can having various body sizes and various top rim sizes.

18. The container of claim 11, wherein the container is configured to attach to a “Sleek” size aluminum can having a 204 body and a 202 top rim.

19. The container of claim 11, wherein the container is configured to attach to a “Slim” size aluminum can having a 202 body and a 200 top rim.

20. The container of claim 11, wherein the lid is configured to allow stacking of additional aluminum beverage cans atop the container.
